(19) United States
(12) Patent Application Publication
(10) Pub. No.: US 2026/0043619 A1
(43) Pub. Date: Feb. 12, 2026

(54) SYSTEM AND METHOD OF CONTROLLED CRYOGENIC COOLING AT LOW PRESSURE AND LOW SYSTEM VIBRATION

(71) Applicant: TGV Rockets Inc., Washington, DC (US)

(72) Inventors: Patrick R.E. Bahn, Washington, DC (US); Justin Beeler, Knoxville, TN (US)

(73) Assignee: TGV Rockets Inc., Washington, DC (US)

(21) Appl. No.: 19/038,698

(22) Filed: Jan. 27, 2025

Related U.S. Application Data
(60) Provisional application No. 63/625,976, filed on Jan. 27, 2024.

(51) Int. Cl. F28D 21/00

(52) U.S. Cl. CPC F28D 21/0001; F28D 2021/0033

(57) ABSTRACT

The present system utilizes a method for precision low pressure, low flow, single phase cooling at temperatures below liquid nitrogen (77 Kelvin) to 170 Kelvin at low cost. In a non-limiting embodiment, and as one aspect of the present invention, the system includes a liquid nitrogen source, a heat exchanger, a pump, a sensor, a controller, a thin wall heat exchanger and a coolant consisting of a eutectic alkene or alkane and insulated lines. In a non-limiting example, the system is attached to a sample that is sensitive to vibration and stress.

### CROSS-REFERENCE TO RELATED APPLICATIONS

This Nonprovisional Patent Application claims the priority benefit of U.S. Provisional Patent Application Ser. No. 63/625,976, filed on Jan. 27, 2024, which is incorporated herein by reference in its entirety.

### BACKGROUND OF THE INVENTION

### Field of the Invention

The present invention relates generally to methods and systems of controlled cryogenic cooling. More specifically, the present invention is a system and a method of controlled cryogenic cooling at low pressure and low system vibration. As a non-limiting embodiment, the present invention uses a two fluid system of a eutectic alkene or alkane and a regulation system to reduce costs and hazards.

### Description of the Related Art

Conventional cryogenic fluids tend to be handled and distributed at pressures and temperatures close to the natural boiling point. Conventional cryogenic fluids will reach pressures in excess of several thousand psi when allowed to heat up in a closed system. Systems that use cryogenic (temperatures below −100 C) compressed gas require expensive high pressure plumbing and regulators.

The new unit or system of the present invention offers a wider range of temperatures that can be provided compared to LN continuous flow (CF) cryocoolers, and it will operate at lower pressure yielding reduced vibration. That will allow a broader variety of experiments to be conducted than with current state of the art cryogenic chillers. In addition, the ability to procure cryochillers at 5× lower costs and significantly lower support costs will allow more institutions to engage in cryo and high energy research.

The current approach to cooling optical mirrors and x-ray mirrors puts them under localized stress and causes vibration.

The present invention overcomes one or more of the shortcomings of controlled cryogenic cooling. The Applicant is unaware of inventions or patent documents, taken either singly or in combination, which are seen to describe the present invention as described and/or claimed.

A system of controlled cryogenic cooling at low pressure and low system vibration is desired.

A method of controlled cryogenic cooling at low pressure and low system vibration is desired.

A method where the device is attached to a mirror which is sensitive to vibration or thermal distortion is desired.

### SUMMARY OF THE PRESENT INVENTION

The present invention is a system and a method of controlled cryogenic cooling at low pressure and low system vibration, preferably at low cost. As a non-limiting embodiment, the present invention uses a two fluid system of a eutectic alkene or alkane and a regulation system (preferably a low-cost regulation system), to reduce costs and hazards.

### BRIEF DESCRIPTION OF THE DRAWINGS

FIG. 1 is a simplistic representation of the composition of the coolant/lubricant referred to as ProPoly 50 according to the present invention, wherein the coolant/lubricant is made up of a 50% propane and 50% propylene mixture by weight;

FIG. 2 is a phase diagram for ProPoly50 to show the freezing point and the compressed liquid state of the coolant throughout its respective operating temperature and pressure. This shows that a sealed system of ProPoly50 can operate between 77 K-367 K while remaining a liquid; and

FIG. 3 is a piping and instrument diagram of the current cryogenic chiller system according to the present invention. This system uses a cryogenic fluid such as LN2 to lower the temperature of the operating fluid (ProPoly50).

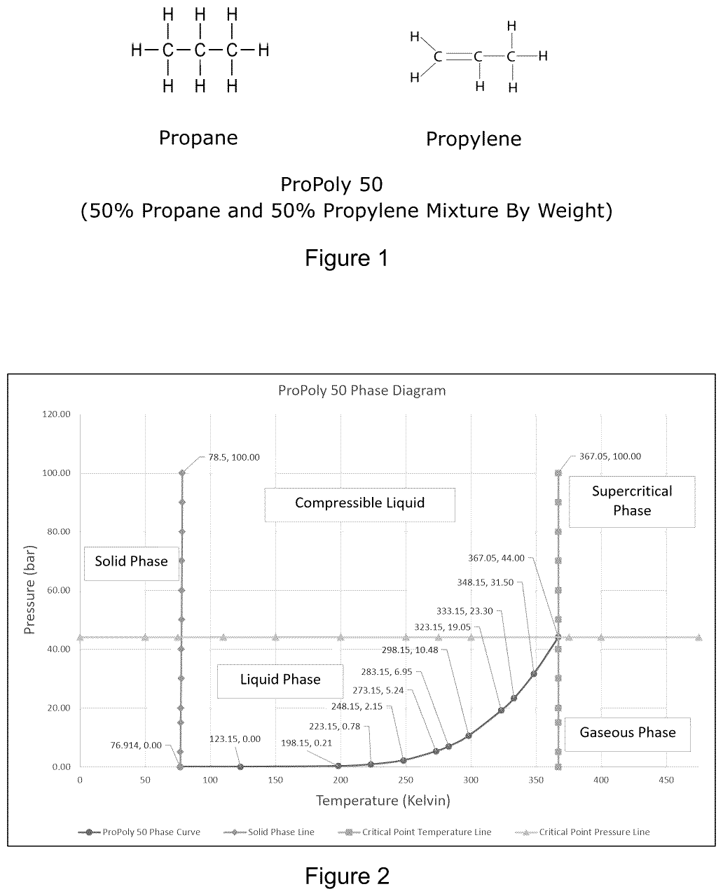

It should be understood that the above-attached figure(s) are not intended to limit the scope of the present invention in any way.

### DETAILED DESCRIPTION OF THE EMBODIMENTS OF THE PRESENT INVENTION

The present invention is a system and a method of controlled cryogenic cooling at low pressure and low system vibration. As a non-limiting embodiment, the present invention uses a two fluid system of a eutectic alkene or alkane and a regulation system (preferably a low-cost regulation system), to reduce costs and hazards.

The Applicant proposes cooling X-ray optics (mirrors) with a system (preferably a low-cost system) and low pressure based on open loop feed of liquid nitrogen (LN) and a controlled loop of ProPoly50 (PP50), a blend of light hydrocarbons. An LN feed at the natural boiling point (77 K and 14 PSI approximately) will set temperature and heat rate in a sealed heat exchanger, which will then feed the optics a low velocity, low pressure fluid around 125 K, with an expanded range of 77-150 K and a target heat rate of 250 W. This system will be leak protected by vacuum guards. ProPoly50 is very similar to propane and has a similar low risk of contamination.

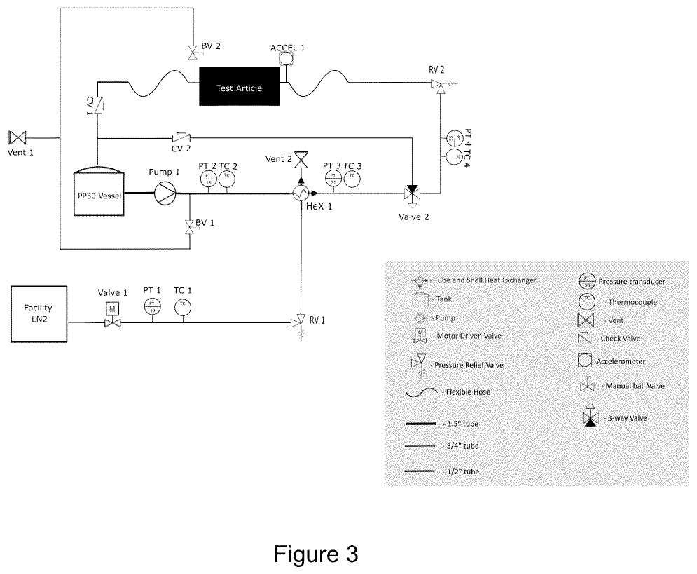

The Applicant's solution (shown in FIG. 3) is to replace the working fluid with a eutectic hydrocarbon blend and run an open loop LN drip feed. These low-pressure, hydrocarbon mixtures mean low pressure plumbing and lower cost components, especially pumps. This will produce a solution at a target price of $80 K/unit.

ProPoly50 is a eutectic blend of propane and propylene that appears to have a freezing point below 77 K (Applicant's original research). The freezing point of similar hydrocarbon mixtures can be selected by varying the ratio of the components or substituting other light hydrocarbons. These mixtures all have lower vapor pressures and lower freezing points. They are non-toxic, clean up easily, and will not migrate through or embrittle metal.

In the new unit or system, 250 W of thermal cooling can be provided by exploitation of about 65 kg of LN2/hour. A 500L Dewar should provide approximately 6 hours of continuous operation. The provision of facility Liquid Nitrogen provides continuous operation for months at a time. A low-cost vacuum guard will be designed as part of the system of the present invention and will be alarmed and provide physical and operational protection to the system with a leak detector. Essentially the evaporator or heat target will have vacuum jacketed lines and an enclosure where practical to detect any coolant leaks. In addition, ProPoly50 and similar blends present lower vibration than LN direct feed as they run at much closer to ambient pressure. They will be non-boiling in the usage case and so will reduce vibration and increase isolation over the current options. Use of flex lines and bellows will dampen any mechanical noise and the low mass pump will run at low speed to minimize vibration.

The Applicant provides a design concept for preferably reducing the overall cost of cryogenically cooling X-ray optics. This is done by using a different coolant, ProPoly50, that will allow the system to operate at lower pressures and lower cost.

FIG. 3 shows a system of the present invention for using the eutectic blend PP50 to cool the test article. This system will pump PP50 through the test article at near ambient pressure and back into the reservoir in a closed circulation loop that is cooled using the cryogenic facility nitrogen. The setup can be modified to accommodate specific test articles and cooling methods.

LN2 facility is a source of generic liquid nitrogen (LN2) at or near the natural boiling point. This can be a conventional large dewar of Liquid Nitrogen supplied by a commercial vendor or this can be an insulated LN2 line from a LN2 plant located somewhere close by. This is a source of low cost, high volume, cold fluid. It can also be a Liquid Argon source, or Liquid oxygen source, or other bulk industrial cryogenic gas up to about 230 K temperature. Above that temperature, commercial scientific freezers would be more economical. LN2 facility is connected to valve #1, pressure transducer #1, thermocouple #1 and the heat exchanger (HX), and then a vent line to provide a continuous source of heat sink at approximately 77 K. Temperature would be different if the LN2 facility were liquid argon, liquid oxygen, etc. This facility keeps the heat exchanger at the minimum target temperature of the supply fluid side of the system. This can be called the called the “Cold Line”.

PP50 vessel is a low pressure, reservoir of the preferred alkane/alkene mix. In this particular embodiment, it is preferably a blend of chemically pure propane and propene at a 50/50 mass ratio to reduce the freezing point below that of the LN2 source fluid. This vessel may store blends of propane, propene, methane, ethane, butane, and other light alkanes/alkenes. PP50 Vessel is connected to the “Warm Loop” via the HX, valves, sensors, and pumps as well the test article.

Tube and shell heat exchanger (HX) is a well-known device for allowing two fluids at different temperatures to exchange heat. This can also be a tube and tube, counterflow, jacket for the PP50 pressure vessel, flat plate, or other type known to one of ordinary skill in the art (OOSIA). The HX is part of the Warm Loop and the Cold Line.

Test Article is the object to be cooled. By sending Propoly50 or other cryogenically cooled liquid to the test article, precise temperature can be maintained by measuring at the thermocouple or by a temperature measuring device in the test article. Test Article is the purpose of the Warm Loop. Test article is attached to a silicon mirror.

Pump is preferably a centrifugal pump to move liquids at the desired operating temperature. The pump must be qualified for the target temperature. Pump is attached to the Warm Loop and a control system.

Motor driven valve #1 works with the system thermocouples and the control system to set the required LN2 flow rate. Motor driven valve #2 is used to either circulate the ProPoly50 back into the tank (for pre-chilling) or circulate through the test article for cooling the desired operating component.

Pressure transducer #1, #2, and #3 serve to alert the control system that a system problem exists and that a freeze or boil condition may be occurring.

Thermocouple #1 (TC-1) is to assure that flow in the LN2 circuit is occurring and that the target temperature is in effect to start the secondary loop cooling. Thermocouple #2 (TC-2) is used to verify the temperature of the coolant going into the heat exchanger. Thermocouple #3 (TC-3) is used to verify the coolant temperature after leaving the heat exchanger.

Vent-1 is used to bleed the ProPoly50 loop to make sure there are no air/gas bubbles present. Vent-2 is to disperse warm nitrogen gas at 80 K and prevent an overpressure condition in the LN2 circuit.

Check valve #1 (CV-1) is to prevent flowing back through the test article when that section is being bypassed. Check valve #2 (CV-2) is used to keep the circulating coolant from going through the pre-chiller loop when it is not in use.

The Applicant demonstrates technical feasibility in Phase I and shows a path toward demonstration in Phase II for the use of ProPoly50 to cryogenically cool x-ray optics.

### Terms and Definitions:

Cryogenic—Relating to or involving the branch of physics that deals with the production and effects of very low temperatures.
ProPoly50—Eutectic blend of light hydrocarbons made up of a mixture of alkene or alkane.
Ln2—Liquid Nitrogen.

Some results of the system and method of the present invention are:
1. A regulated flow of an alkane/alkene blend of propane/propene in the working loop provides a tuned temperature between the freezing point of the blend up to the safe pressure limit or −0° C.
2. A regulated flow of an alkane/alkene blend can be exposed to liquid nitrogen and provide a tuned temperature between the freezing point of the blend up to the safe pressure limit or −0° C.
3. That as above, the liquid nitrogen can be replaced by liquid argon, neon, carbon dioxide, oxygen or other cryogens between 50 K and 270 K.
4. That other alkene/alkane blends can also be used such as propane/butane, propane/pentane, where a low vapor pressure curve is noted.
5. That an alkane or alkene can be used, where the cold line supply is above the freezing point of the selected alkane or alkene at pressures below 60 PSI.
6. That an alkane or alkene can be used, where the cold line supply is above the freezing point of the selected alkane or alkene at pressures below 300 PSI.
7. That vacuum jacketed lines are used to contain and prevent hazardous events.
8. That a leak detector is placed to the vacuum jacket to detect leaks and alert operators to a risk condition.

It is to be understood that the present invention is not limited to the embodiments and non-limiting examples described above or as shown in the attached figures, but encompasses any and all embodiments within the spirit of the invention.

What is claimed is:

1. A system of controlled cryogenic cooling at low pressure and low system vibration, said system comprising:
a liquid nitrogen source;
a heat exchanger for allowing two fluids at different temperatures to exchange heat;
a pump;
a sensor;
a controller;
a thin wall heat exchanger;
insulated lines; and
a coolant comprising a eutectic alkene or alkane.

2. The system according to claim 1, wherein said pump is a centrifugal pump.

3. The system according to claim 1, wherein said coolant is two or more selected from the group consisting of propane, propene, butane, and propene/butane.

4. The system according to claim 3, wherein a test article is attached to a distortion sensitive mirror.

5. The system according to claim 1, wherein a test article is attached to a distortion sensitive mirror.

6. A method of controlled cryogenic cooling at low pressure and low system vibration, said method comprising the step of:
providing a system that comprises a liquid nitrogen source, a heat exchanger, a pump, a sensor, a controller, a thin wall heat exchanger, insulated lines, and a coolant comprising a eutectic alkene or alkane, wherein said heat exchanger allows two fluids at different temperatures to exchange heat.

7. The system according to claim 6, wherein said pump is a centrifugal pump.

8. The system according to claim 6, wherein said coolant is two or more selected from the group consisting of propane, propene, butane, and propene/butane.

9. The system according to claim 8, wherein a test article is attached to a distortion sensitive mirror.

10. The system according to claim 6, wherein a test article is attached to a distortion sensitive mirror.
